(19) United States
(12) Patent Application Publication
(10) Pub. No.: US 2008/0140860 A1
(43) Pub. Date: Jun. 12, 2008

(54) MEDIA ROUTING

(76) Inventor: Edward Balassanian, Kirkland, WA (US)

Correspondence Address: BLACK LOWE & GRAHAM, PLLC, 701 FIFTH AVENUE, SUITE 4800, SEATTLE, WA, 98104, US

(21) Appl. No.: 11/933,094

(22) Filed: Oct. 31, 2007

Related U.S. Application Data
(63) Continuation of application No. 10/852,308, filed on May 24, 2004.
Application No. 10/852,308 is a continuation of application No. 09/498,016, filed on Feb. 4, 2000, now abandoned.

(51) Int. Cl. G06F 15/16

(52) U.S. Cl. 709/245

(57) ABSTRACT

A method and system for routing media from a source resource on a source appliance across a network to a destination resource on a destination appliance. The particular destination resource on a destination appliance can be specified. Alternatively, the particular destination appliance is specified but the particular resource on the destination appliance is not specified. An intermediate appliance having a resource for converting the media from a source media-type to a destination media-type can be further specified. A user interface is provided to allow a user to specify the source and destination of the media. A discovery process is provided to allow appliances to discover the other appliances and resources available on the network.

### TECHNICAL FIELD

The present invention relates generally to routing, transforming, and delivering media between network resources.

### BACKGROUND

The following application is incorporated by reference as if fully set forth herein: U.S. application Ser. No. 10/852,308 filed May 24, 2004.

The Internet is a global communications network interconnecting a vast number of computers and networks via communications links. The Internet represents a highly distributed system made up of routers and hosts. Hosts are computers that exist at the edges of the network and generate the traffic that routers in turn deliver to other hosts. An example of a host generating traffic is a computer using a web browser specifying a request for a web page. Data sent from one host to another on the Internet might go through many routers before reaching its destination host.

Routers on the Internet make routing decisions based on Internet Protocol (IP) address and knowledge gained from surrounding routers. An IP address is a unique number identifying every host connected to the Internet. Routers have ports, or physical connections, for sending and receiving data. Routers receive data, examine the header information appended to the data for a destination address (for example, the IP address of the destination host), and compare the destination address against an internal database called a routing table. The routing table has information about which of its ports data destined for a particular address should be sent out. Thus, a data packet comes in one port of a router, its destination address is examined and compared to its routing table, and the data is then sent out a particular output port on its way to the next router (or the destination host if that host is connected to this router).

Routers and hosts exist in subnets that are connected to other subnets, via routers, forming the Internet. New subnets can be added at any time, as can faster routers. Since the Internet is inherently organic, addition of new components requires only localized changes and does not necessitate a massive network upgrade. The network, as represented by the Internet, is thus capable of automatically adjusting and absorbing new functionality

In a typical client-server model on the Internet, a client computer first requests information from a server computer in the form of an HTTP (Hypertext Transfer Protocol) request. For example, the client computer may request a particular web page from the server computer. The server computer needs the application to which the request is being sent running and listening for data at a particular port on the server. The server processes the HTTP request and responds by sending the requested web page to the client in the form of an HTTP response.

Instead of a user at a client computer manually transmitting an HTTP request (for example, by typing in the Uniform Resource Locator (URL) of a web page address or by clicking on a link to a web page), Internet browsers on client computers can be configured to have web pages automatically “pushed” to them from server computers. This is sometimes referred to as “subscribing” to a web site. Subscribing to a web site allows the information to which the user subscribed to be sent to the browser at regular intervals. This form of push technology still requires the client computer to issue an HTTP request for the information; the client web browser is configured by the user to automatically contact the server web site subscribed to at intervals specified by the user to check to see if information has been updated and if so, issue an HTTP request for the information. Therefore, it would be desirable to enable a computer on a network to send data to another computer without the recipient computer having to first request the information and without the recipient computer to have a particular application the data is destined for running and listening on a particular port.

Networks such as the Internet use addressing schemes such as Internet Protocol to uniquely identify every computer connected to the Internet. In the client-server environment, when a host sends the HTTP response to an HTTP request, the HTTP response is only sent to the client computer, and the client computer via an application such as a web browser decides how to handle the data, for example, by displaying the data on the screen in the form of a web page. However, the server computer can not control to which resource on the client (e.g., the screen, hard disk drive, or speakers) the data should be directed. Therefore, it would be desirable to have a system that allows a host to transmit data to a particular resource on another host.

Many different types of appliances, such as telephones and hand-held computers, are now being connected to the Internet. Such appliances often have very little memory and have limited display capabilities. As a result, such appliances have difficulty processing high-bandwidth data. It would be desirable to have a system that can transmit data to such devices more efficiently so as not to overload the their limited capabilities.

### SUMMARY OF THE INVENTION

As set forth below, a need exists for an improved method and system for routing data from a source resource on a source appliance across a network to a destination resource on a destination appliance. The method and system of the invention satisfies that problem.

According to one aspect of the invention, there is a method and system provided that routes data from a source resource on a source appliance to a destination appliance without specifying a specific destination resource on the destination appliance to which the data is routed. A mapping algorithm on the destination appliance determines the destination resource to which the data is routed. Alternatively, a particular destination resource is specified.

According to another aspect of the invention, the data can be routed from a source resource on a source appliance, to any number of intermediate resources on intermediate appliances, and finally to a destination resource on a destination appliance.

According to another aspect of the invention, a system and method is provided to discover the appliances connected to the network, and to discover the resources connected to the appliances.

According to another aspect of the invention, a system and method is provided for a user to selectively route data from a source resource on a source appliance to a destination appliance or a destination resource on the appliance.

### BRIEF DESCRIPTION OF THE DRAWINGS

The accompanying drawings illustrate certain embodiments of the invention.

FIGS. 1a and 1b illustrate a system according to one embodiment of the present invention.

FIG. 2 illustrates a sample of the contents of a Table Of Known Appliances incorporated in the embodiment as shown in FIGS. 1a and 1b.

FIG. 3a illustrates a sample of the contents of a Table Of Resources On An Appliance incorporated in the embodiment as shown in FIGS. 1a and 1b.

FIG. 3b illustrates a sample of the contents of a Table Of Special Cases incorporated in the embodiment as shown in FIGS. 1a and 1b.

FIGS. 4 and 5 are flowcharts illustrating a process of discovering appliances and resources executed by the system shown in FIGS. 1a and 1b.

FIG. 6 is a flowchart illustrating a process of the user controlling the routing of data through the system shown in FIGS. 1a and 1b.

FIG. 7 is a flowchart illustrating a process of routing data executed by the system shown in FIGS. 1a and 1b.

FIG. 8 is a flowchart illustrating a process of routing data executed by the system shown in FIGS. 1a and 1b.

FIGS. 9a and 9b illustrate sample user interfaces for routing data operating on the system shown in FIGS. 1a and 1b.

FIGS. 10a, 10b, 10c and 10d illustrate sample user interfaces for configuring resources operating on the system shown in FIGS. 1a and 1b.

FIG. 11 illustrates a sample user interface for routing data operating on the system shown in FIGS. 1a and 1b.

FIG. 12 is a flowchart illustrating a process of routing data executed by the system shown in FIGS. 1a and 1b.

### DETAILED DESCRIPTION

### Media Objects

A system is provided that encapsulates any resource on an appliance providing each resource with a common interface. An example of an appliance is a computer, and examples of resources on such an appliance are a speaker, a microphone, a screen, and a voice-to-text application. Each resource is encapsulated via object-oriented programming techniques. An encapsulated resource is referred to as a “media object”. Once encapsulated, the only way to access the resource is through the media object. U.S. patent application Ser. No. 09/304,973 entitled “Method And System For Generating A Mapping Between Tripes Of Data” (the “mapping algorithm”) and U.S. patent application Ser. No. 09/474,664 entitled “Method And System For Data Demultiplexing” (the “Demux algorithm”) (collectively referred to as the “conversion system”), incorporated herein by reference, discuss an intra-appliance conversion system which enables data output from one media object to be converted into a format suitable for input to a destination media object. The mapping algorithm determines the sequence of routines to process a stream of data. The Demux algorithm is the instantiation of state associated with the sequence of routines processing the stream of data.

Once the appliance is connected to a network, the same algorithms used to manage the routing of data intra-appliance can be applied to the routing of data between appliances. All resources, whether on a particular appliance or distributed across a network are treated as network resources. Network protocols such as TCP, IP and Ethernet can be encapsulated as media objects so that the problem of transferring data across a network is solved by the same conversion routines described in the aforementioned patent applications. The resources on an appliance are treated as a subnet, and routing between two appliances becomes the same problem as routing between two subnets on the Internet. Much like an IP packet can visit multiple network hops, data can be routed through multiple appliances in the delivery of data from a start to an end point. The data can be transformed by the appliance at each hop. This distributes the processing of the data across all the appliances in the path. Further, since standard network protocols are used for inter-appliance communication, the system is able to extend its communications capabilities to appliances that do not have resources encapsulated as media objects.

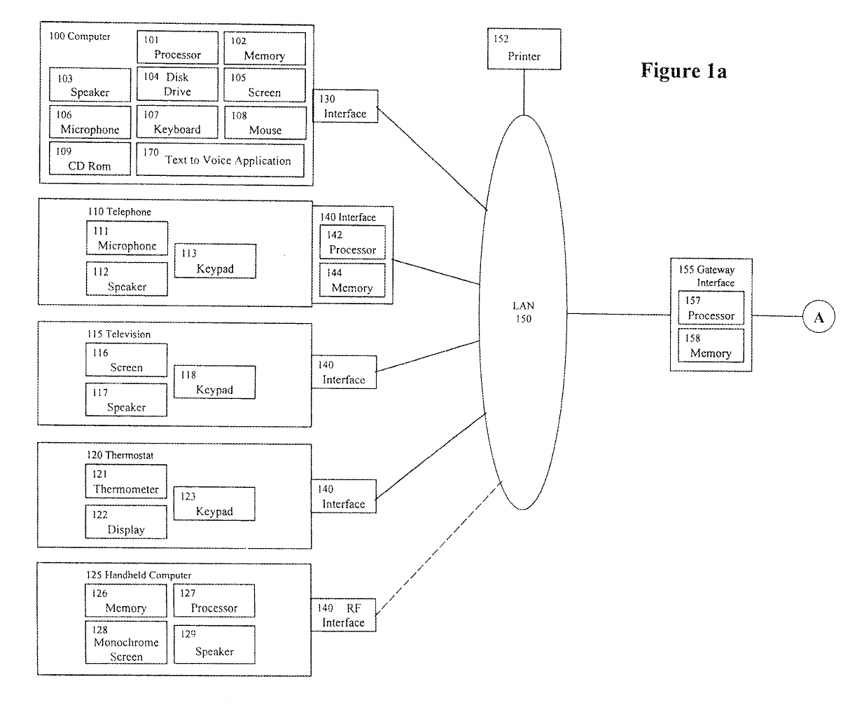

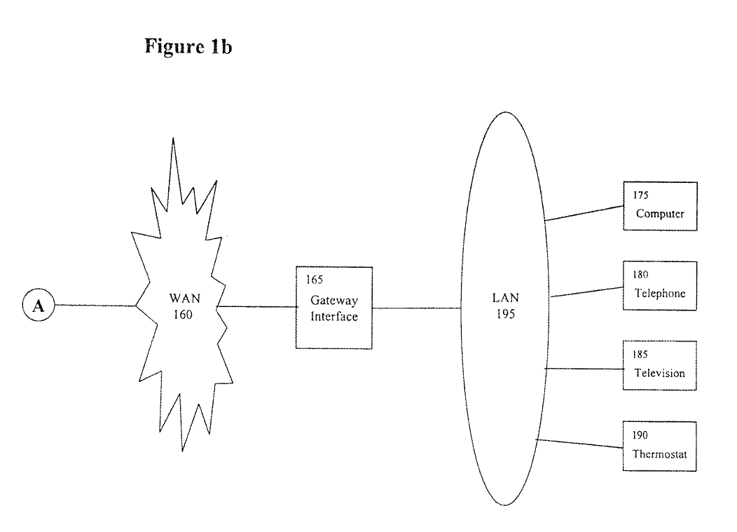

FIG. 1 shows an embodiment of a system incorporating the present invention. In general, the embodiment provides a method and apparatus for routing media from a source resource on a source appliance connected to a network to a destination resource on a destination appliance connected to a network (sometimes referred to as “target resource” and “target appliance”). In this embodiment, the system includes the following appliances: computer 100, telephone 110, television 115, thermostat 120, handheld computer 125 and printer 152. Each resource on appliances 100, 110, 115, 120 and 125 is encapsulated as a media object. Other resources encapsulated as media objects include the various networking protocols operating on each appliance or interface, including TCP, IP, UDP, Ethernet, etc. The conversion system operates on processors 101, 127, 142 and 157.

Computer 100 includes a processor 101, memory 102, interface 130, and the following resources: speaker 103, disk drive 104, screen 105, microphone 106, keyboard 107, mouse 108, CD-ROM 109 and text-to-voice application 170.

Telephone 110 includes the following resources: microphone 111, speaker 112 and keypad 113. Television 115 includes the following resources: screen 116, speaker 117 and keypad 118. Thermostat 120 includes the following resources: thermometer 121, display 122 and keypad 123. Computer 100 is connected to network 150 via interface 130. Interface 130 can be an Ethernet adapter card or other network adapter. Appliances 110, 115 and 120 are connected to network 150 via interfaces or network adapters 140.

Network adapter 140 includes processor 142 and memory 144. Network adapter 140 encapsulates as media objects via standard object oriented programming techniques the resources available on each appliance to which it is connected. Each resource, once encapsulated as a media object, is thereby made available as a network resource available to any of the other network resources. The conversion system operates on network adapter 140.

Network 150 can be a local area network or other electronic network connecting appliances geographically close to one another. Network 150 is connected to gateway interface 155. Gateway interface 155 includes processor 157 and memory 158. Gateway interface 155 connects network 150 to network 160. Network 160 can be the Internet or other network. Gateway 165, computer 175, telephone 180, television 185 and thermostat 190, attached to LAN 195, all operate in the same manner and have the same resources as do the corresponding appliances attached to LAN 150.

Handheld computer 125 includes the following resources: memory 126, processor 127, monochrome screen 128 and speaker 129. Handheld computer 125 is connected to LAN 150 via network adapter 141. Network adapter 141 is an RF interface to LAN 150. The conversion system operates on network adapter 141.

Printer 152 is connected to network 150 and does not have the conversion system operating on it. Its resources are not encapsulated as media objects.

### Media Routing

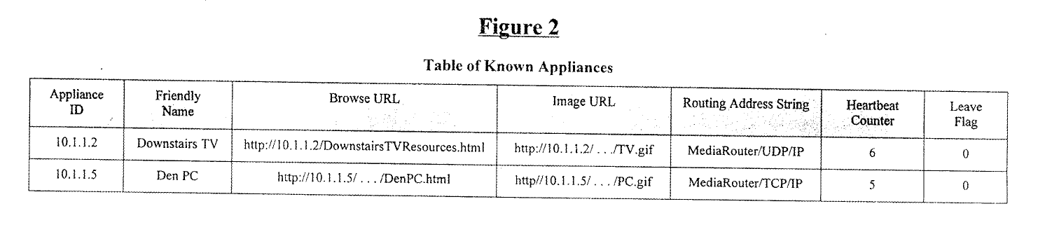

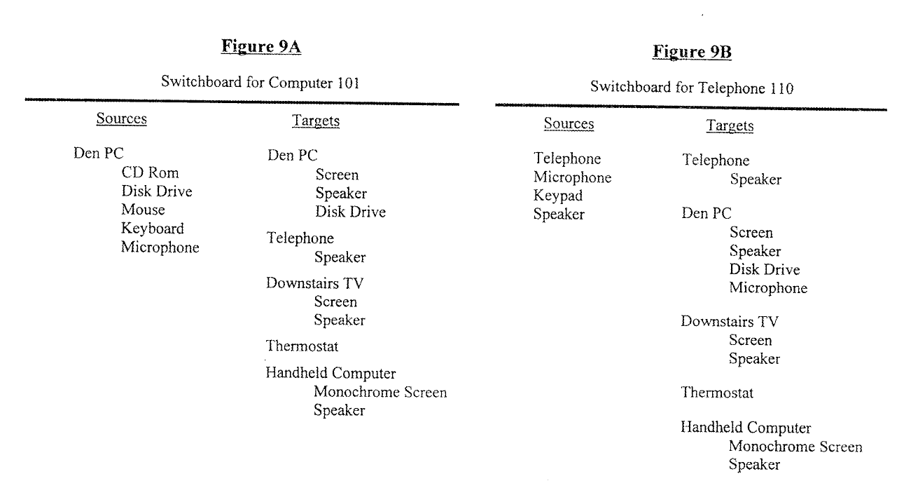

To route content from a source resource on a source appliance to a target appliance or target resource, information about the target appliance must be known to the source appliance to appropriately encapsulate the content. FIG. 2 is an example of a Table of Known Appliances. The table is stored in the memory of the source appliance or is otherwise accessible to the source appliance. The table lists the following attributes about each appliance connected to the local network: appliance ID, which by example is the IP address of the appliance; a Friendly Name of the appliance, which is a name recognizable to a user, for example “Downstairs TV”; a Browse URL (Uniform Resource Locator) which is the URL of the page containing a menu which lists the resources on the appliance and lists the appliances and resources connected to that appliance (this menu is discussed in detail below with reference to the FIGS. 9a and 9b); Image URL, which contains the URL of the graphical image that might appear next to the Friendly Name of the appliance on a menu presented to a user, for example an image of a television; and the appliance routing address string, which contains the series of hops through which the data must be routed to place the data in a format that the destination appliance can read, for example, MediaRouter/UDP/IP. An example of such a routing address string is “MediaRouter(13)/TCP(0)(E, 9999)/IP(0)(-,10.1.1.2)”. Illustratively, data can be sent via HTTP, and the media router, which uses HTTP as its header, includes the source content-type, for example, image GIF or text/HTML, and the content length representing the number of bytes in the payload. The source content-type is used by the destination appliance's mapping engine to determine the target resource on the destination appliance.

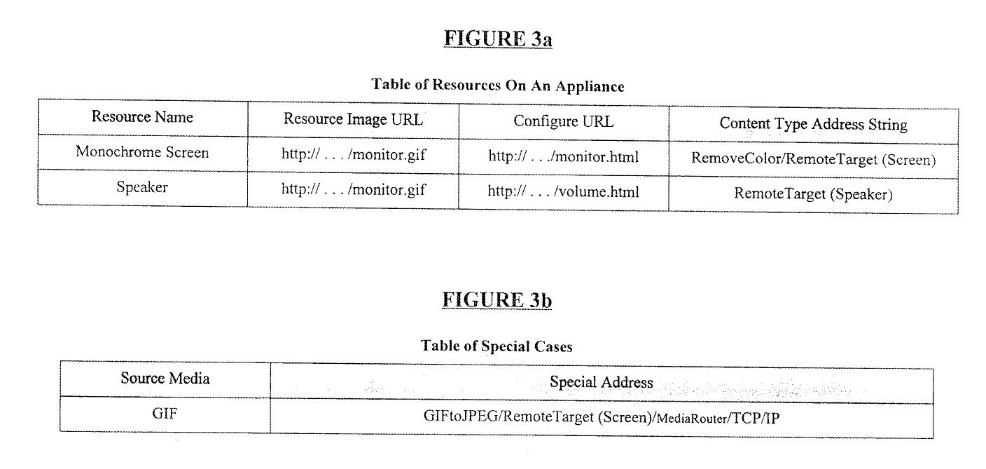

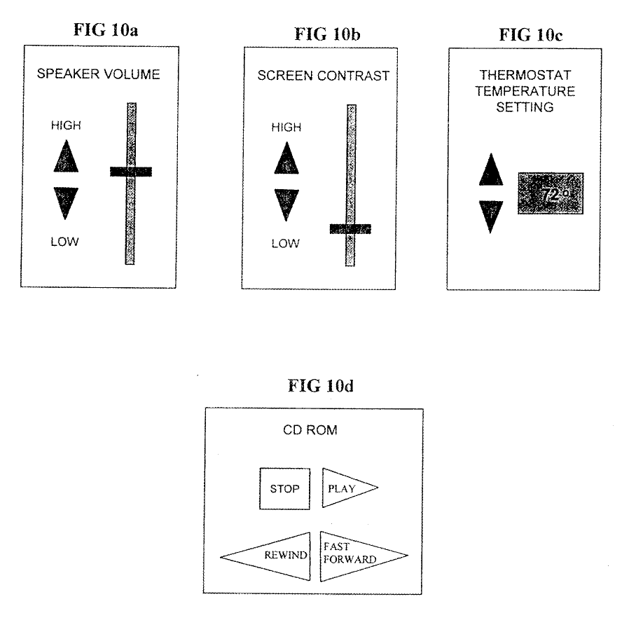

To route content from a source resource on a source appliance to a destination resource on a destination appliance, information about the destination resource must be known to the source appliance to appropriately encapsulate the content for routing across the network. FIG. 3a is an example of a Table Of Resources On An Appliance. One of these tables in FIG. 3a exists for each appliance listed in the Table Of Known Appliances. The Table Of Resources On An Appliance is stored in the memory of the source appliance or is otherwise accessible to the source appliance. As illustrated in FIG. 3a, the table lists the following attributes about the resources connected to an appliance: Resource Name, which is a name recognizable to a user, for example “Speaker”; a Resource Image URL, which is the URL of the graphical image that appears next to the Resource Name; Configure URL, which is the URL of the web page containing the controls to configure the resource (FIGS. 10a-10d, discussed below, are examples of such a web page); and the Content-Type Address String, which contains the format of the type of media that the resource can process. Illustratively, data is sent via HTTP, and the HTTP media router, or header, includes the destination content-type address string, for example RemoteTarget(Speaker). The destination content-type is used by the destination appliance's mapping algorithm to map the content to the specified resource.

If a particular resource on a destination appliance needs a special conversion routine performed on it prior to transmission depending on the type of source content, then an entry for that source content type will appear in the Table Of Special Cases in FIG. 3b under the heading Source Media. The special target address string appears under the heading Special Address. For example, if the source content-type is GIF, and the target resource needs GIF translated to JPEG, then an entry may appear as shown in the Table Of Special Cases in FIG. 3b with the following special routing address string: “GIFtoJPEG/RemoteTarget(Screen)/MediaRouter/TCP/IP”. This entry is used as the routing address string in the header.

One embodiment allows data, or “content” to be routed from a source resource on one appliance to a target appliance without specifying to which resource on the target appliance the content is directed. For example, content such as JPEG from CD-ROM drive 109 on computer 100 can be routed to television 115. When the embodiment routes content from one appliance to another, it does so without having received a request from any of the targeted resources.

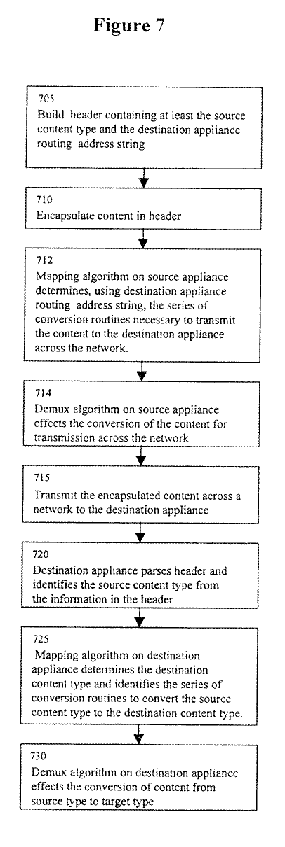

Routing data, or “content” such as audio or video from a source resource to a target appliance located across a network without specifying the target resource on the target appliance will now be described with reference to FIG. 7. First, a header is built containing at least the source content-type and the destination appliance routing address string (Step 705). The source content-type describes the type of media the data represents, for example, JPEG, MPEG, GIF, HTML, PCM, MP-3, etc. The destination appliance routing address is found in the table of known appliances. Next, the content is encapsulated in the header (Step 710). The mapping algorithm on the source appliance then determines, using the destination appliance routing address string, the series of conversion routines necessary to transmit the content to the destination appliance across the network (Step 712). Then the Demux algorithm on the source appliance effects the conversion of the content for transmission across the network (Step 714). The encapsulated content is then transmitted across the network to the destination appliance (Step 715). Upon receipt of the encapsulated content, the destination appliance parses the header, identifying the source content-type from the information in the header (Step 720). The mapping algorithm then determines what the target content-type should be based on the available resources on this appliance, and identifies the series of conversion routines to convert the source content-type to the target content-type (Step 725). Finally, the destination appliance converts the data from the source type to the target type using the Demux algorithm which routes the data through a sequence of routines identified by the mapping algorithm to effect the conversion of the data to the target format (Step 730).

Thus, in the example of routing JPEG content from CD-ROM 109 to television 115, the user need not specify that the content be routed to screen 116. Using the switchboard (described below with reference to FIGS. 9a and 9b), the user can direct that the content from CD-ROM 109 be routed to television 115. The header is built containing at least the content-type, here JPEG, and the routing address string of television 115, which by example could be MediaRouter/UDP/IP. The content is encapsulated in the header. The mapping and Demux algorithms operating on processor 101 use the routing address string of television 115 to determine the format to transmit the content, which by example uses the HTTP, UDP and IP protocols, and effect the conversion. The mapping algorithm operating on interface 140 connected to television 115 then determines, based on the source content-type, how to best convert the content so it can be understood by one of the resources on television 115. In the example of JPEG content from CD-ROM 109 transmitted to television 115, the mapping algorithm might determine that bit-map is the best content-type to which the content should be converted, and then the Demux algorithm would effect the conversion and the content would be displayed on the screen.

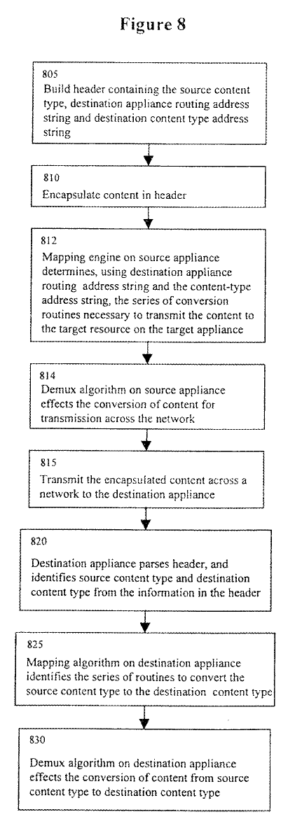

Alternatively, the user can specify the particular resource on the destination appliance to which the content is to be routed. Routing content from a source resource on a source appliance to a specified target resource on a target appliance will now be described with reference to FIG. 8. First, a header is built containing the source content-type, the target appliance routing address string (obtained from the Table of Known Appliances in FIG. 3a), and the target content-type address string (from the Table of Resources On An Appliance) (Step 805). If the destination resource needs a particular content-type converted to another content-type before receiving it, then the entry under Special Address from the Table of Special Cases in FIG. 3b is used as the destination appliance routing address string instead of the entry found in the Table of Known Appliances. Next, the content is encapsulated in the header (Step 810). The mapping algorithm on the source appliance then determines, using the destination appliance routing address string and the content-type address string, the series of conversion routines necessary to transmit the content to the target resource on the target appliance (Step 812). Then the Demux algorithm on the source appliance effects the conversion of the content for transmission across the network (Step 814). The encapsulated content is then transmitted across the network o the destination appliance (Step 815). Upon receipt of the encapsulated content, the destination appliance parses the header, identifying the source content-type and the target content-type from the information in the header (Step 820). The content-type address string identifies the targeted content-type. The mapping algorithm then determines the series of conversion routines to convert the source content-type to the target content-type (Step 825). Finally, the Demux algorithm effects the conversion of the content from the source content-type to the target content-type by executing the sequence of conversion routines determined by the mapping algorithm. (Step 830).

An example of the routing of data according to the steps in FIG. 8 will now be described. The user may choose to send content from a text file, such as an HTML email, stored on disk drive 104 to speaker 112 on telephone 110. The content would be routed as described above with reference to FIG. 8 to interface 140 on telephone 110. The mapping algorithm running on interface 140 would recognize that one of the conversion routines necessary to convert HTML to PCM is a resource located on an appliance listed in its Table of Known Appliances (in FIG. 1, the text-to-voice application is a resource on computer 100). The mapping algorithm on interface 140 would include text-to-voice application 170 in its series of conversion routines. The Demux algorithm on interface 140 would then route the content through the series of conversion routines specified by the mapping algorithm, including encapsulating the content in the appropriate header to transmit the content to text-to-voice application 170. Text-to-voice application 170 would then operate on the content to translate the HTML to PCM, and then the content is encapsulated in the appropriate header, sent through the series of conversion routines determined by the mapping algorithm, and transmitted back to speaker 112 on telephone 110 in accordance with the steps in FIG. 8. The content would now be in PCM format, a format understood by speaker 112, and the HTML email is heard on speaker 112. Those skilled in the art will recognize that interface 140 on telephone 110 need not have a large amount of memory or processing capacity to store all possible conversion routines and convert all types of data; as long as a needed resource is available somewhere on the network, interface 140 can take advantage of the resources and processing power of other appliances on the network. This reduces the complexity and cost of interface 140.

In another example, the user may choose to send color video content from CD-ROM 109 on computer 100 to monochrome screen 126 on handheld computer 125. The content would be routed as described above with reference to FIG. 8. Importantly, the content-type address string found in the Table Of Resources (FIG. 3a) for the monochrome speaker is RemoveColor/RemoteTarget(Screen). RemoveColor indicates to the mapping algorithm on Computer 100 to include in the series of conversion routines a routine to strip out the color from the video stream content, thereby reducing the bandwidth necessary to transmit the content to handheld computer 125, and reducing the processing power necessary on handheld computer 100.

In another example, the user can transmit content from a source resource located across a wide area network (WAN) to a target gateway interface, and the mapping and Demux algorithms operating on the gateway interface determine how the source content should be converted based on the appliances and resources connected to the LAN. The user on a WAN only needs to know the network address of the gateway interface. The gateway interface then determines how to best handle the arriving content from the WAN, which can be determined on-the-fly through the mapping algorithm on gateway interface or set by the home user through a pre-determined mapping (for example, the home user may want all video mapped to his computer screen). Such an example will now be described with reference to FIG. 1. A user at computer 175 might choose to transmit content from the CD-ROM on his computer to the home of the person located at gateway interface 155, but the sender does not care how the content is processed once it arrives. This example is similar to that described with reference to FIG. 7 above. The content is encapsulated in a header containing the target appliance routing address string, which here is the routing address string of gateway interface 155, and transmitted across LAN 195, through gateway interface 165, across WAN 160 to gateway interface 155. The mapping algorithm operating on gateway interface 155 determines the sequence of conversion routines to convert the CD-ROM content-type to an appropriate target content-type suitable for one of the appliances connected to LAN 150. Alternatively, the home user can set the mapping engine in gateway interface 155 to

Alternatively, the user at computer 175 can access the switchboard (described below with reference to FIGS. 9a and 9b) of gateway interface 155 to see the appliances and resources connected to LAN 150. By accessing the switchboard, the user can select the particular appliance on LAN 150, or resource on an appliance connected to LAN 150, to which content can be directed from computer 175.

Another embodiment will now be described with reference to FIG. 12. In this embodiment, content may be routed from a source resource to a destination resource making hops to other appliances along the route. First, the source content-type and destination content-type are examined by the mapping engine on the source appliance to determine the series of conversion routines necessary to convert the source content-type to the destination content-type. If the mapping algorithm determines that a resource located on an appliance other than the source or destination appliance is needed to convert the content to the appropriate format for the destination appliance, then the mapping algorithm will indicate that the routing address string for this intermediate appliance in the header must be included in the header (Step 1202) Next, a header is built containing the source content-type, destination appliance routing address string, destination content-type address string, and any routing address strings for other appliances the content must be routed through along the way to the destination appliance, referred to as intermediate appliances (Step 1205). Next, the content is encapsulated in the header (Step 1210). Then the Demux algorithm on the source appliance effects the conversion of the content for transmission across the network to the next intermediate appliance (Step 1215). The encapsulated content is then transmitted across the network to the next intermediate appliance (Step 1220). The intermediate appliance parses the header, and identifies the source content-type and destination content-type from the information in the header (Step 1225). Then the mapping algorithm operating on the intermediate appliance identifies the series of routines to convert the source content-type to the destination content-type, or to convert the source content-type to an intermediate content-type (Step 1230). The intermediate content-type might be the output of a series of conversions that must occur to convert the source content-type to the destination content-type. Next, the Demux algorithm effects the conversion routines identified by the mapping algorithm in step 1230 (Step 1235). If the content is on the destination appliance, then it is routed to the destination resource on the appliance (Steps 1240 and 1245). If the content is not at the destination appliance, then the header is stripped of this intermediate appliance's routing address string, and the source content-type is changed to content-type of the output of the conversion routine on this appliance (Steps 1240 and 1248), the content is transmitted to the next appliance indicated in the header (Step 1250), and the flowchart loops back up to Step 1225. The flowchart continues this loop until the content has been routed through all the appliances necessary to convert the source content-type to the destination content-type.

An example following the steps of FIG. 12 will now be discussed. A user might wish to route sound from microphone 111 on telephone 110 to screen 116 on television 115. To accomplish this, the mapping engine on interface 140 connected to telephone 110 would identify the series of conversion routines to convert the microphone's PCM content-type to the television screen's bitmap content-type. One of these identified conversion routines, text-to-voice/voice-to-text application 170, is encapsulated as a media object on computer 100. Since all resources encapsulated as media objects on the network are listed in the various Tables Of Resources, they are available to the mapping algorithm as if they were on the source appliance itself. The mapping algorithm would include computer 100 as an intermediate hop to which the content will be routed. Once the message is received by computer 100; its header is examined and the mapping algorithm operating on computer 100 would determine from the source content-type of PCM and the destination content-type of bitmap that the content needs to be routed through voice-to-text application 170. The Demux algorithm operating on computer 100 would effect the conversion of the content. The header would be stripped of computer 100's routing address string, and the source content-type in the header would be updated to reflect conversion of the content to “text”. The message would be transmitted across the network to television 115. Network adapter 140 on television 115 is the last hop in the series of appliances the content was routed through. The header would be parsed, and the mapping algorithm would map the source content-type, which is now “text”, to the destination content-type of bitmap, and the Demux algorithm would effect the conversion. The content would then be routed to screen 116.

### Switchboard

The switchboard is the user interface on an appliance which is used to map content from one appliance or resource to another, and is used to configure resources. Each appliance has its own switchboard. One embodiment of a switchboard is shown in FIGS. 9a and 9b. The switchboard for a particular appliance may be a web page displayed in a web browser showing on the left side of the screen the list of resources on the appliance that are sources of content, and on the right side a list of appliances known to this appliance, that is, those appliances appearing in the Table Of Known Appliances shown in FIG. 2. Further, the switchboard can display the resources on each known appliance capable of receiving content. The switchboard is used to direct content from a source resource listed on the left of the switchboard to a target appliance, or target resource on an appliance, listed on the right of the switchboard a shown in FIGS. 9a and 9b.

The switchboard is also used to access the controls for resources. When a user clicks on the name of a resource, the browser accesses the URL of the resource stored in the Table of Resources On An Appliance (FIG. 3a). For example, a user clicking on a speaker resource would see a volume control pop up in the browser such as that shown in FIG. 10A. FIGS. 10b, 10c and 10d are additional examples of controls for resources.

In this embodiment, the user can remotely access the switchboard of any appliance. This is referred to as “browsing” the appliance. For example, the user sitting at computer 100 would initially see the switchboard shown in FIG. 9a. If the user wanted to map incoming telephone calls from telephone 110 to television 115, the user would click on the word “telephone”. This causes the browser to access the URL of the telephone's switchboard stored in the Table Of Known Appliances under the Browse URL heading, and to display the telephone's switchboard as shown in FIG. 9b. The user now has full remote control over the resources on the telephone. Using this method, the various appliances such as the telephone that have no screen and limited input controls can be browsed and configured. Further, any appliance on the network can be remotely controlled and configured from one location on the network just by accessing the switchboard for the appliance.

In another example, the user at computer 175 can control thermostat 120 from computer 175. This is done by the user at computer 175 accessing the switchboard on gateway interface 155, which would show the thermostat on the right side of the switchboard, and then selecting the thermostat, which would display the switchboard of the thermostat (the URL of the thermostat switchboard is stored in the Table of Known Appliances on gateway interface 155 under the heading Browse URL in FIG. 2). The thermostat switchboard lists the keypad as a source of content on the left side of the screen. Selecting the keypad accesses the URL of the keypad controls, which can look like that shown in FIG. 10c. The user at computer 175 then has access to the controls of thermostat 120.

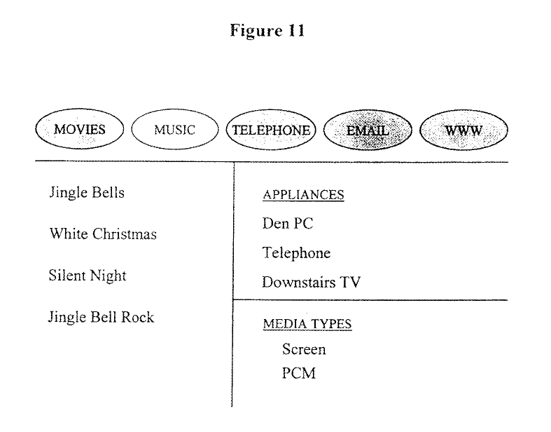

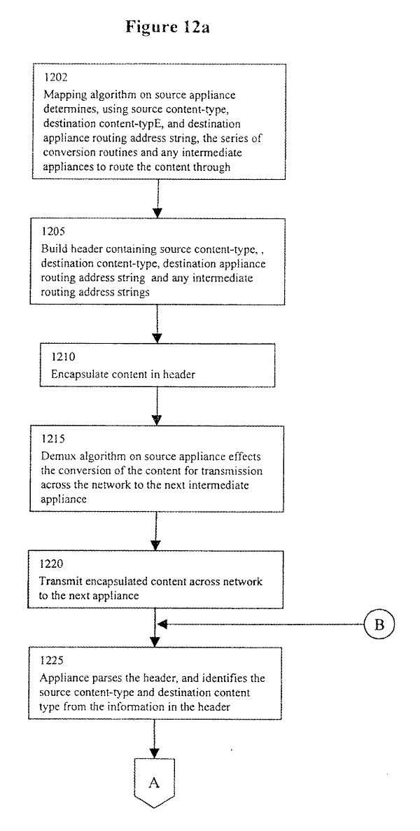

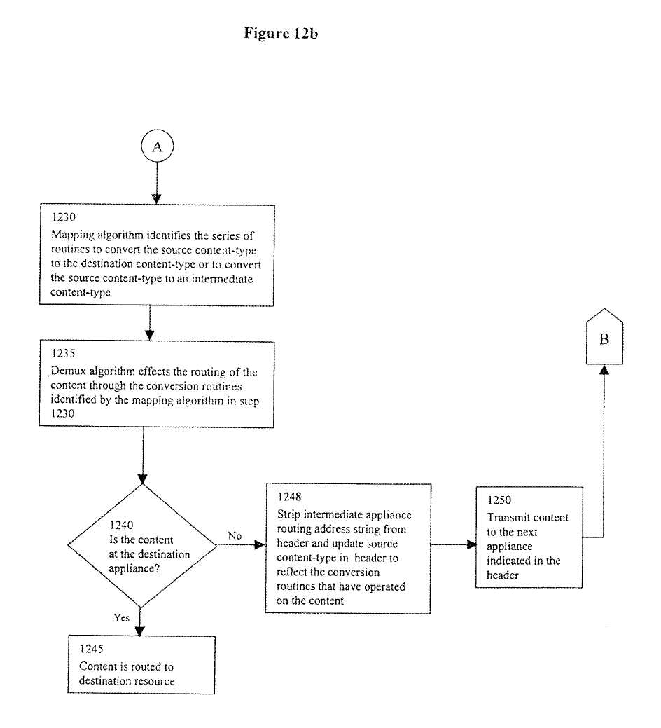

An alternate embodiment of a switchboard is shown in FIG. 11. In this embodiment, each appliance can generate a switchboard. Such a switchboard provides a list of all sources of content in the network and a list of all the destinations for content on the network. At the top of the screen as shown in FIG. 11, the switchboard displays icons representing source categories of content such as “email”, “music”, or “movies”, for a user to choose as a source. For example, “music” for the user's music compact disks. When “music” is selected, the list of music titles is displayed, and the user can now select from the list to map a favorite song to a target appliance, a target resource, or a target content-type.

In another embodiment, the screen displays categories of sources content, such as Devices, Music, etc. When the user selects a category, the user is then presented with sub-categories of content. For example, if the user selects the “Music” category, then the user is presented with the sub-categories “Jazz”, “Rock”, “Classical”, etc. When the user selects one of the sub-categories of content, the user is presented with a list of content on the left of the screen, and a list of destinations on the network that can accept such content on the right side of the screen. For example, if the user selects Jazz, then on the left side of the screen the user will be presented with a list of Jazz songs available somewhere on the network, for example on compact disks in various stereos on the network. On the right side of the screen the user is presented with a list of the destination resources on the network that can accept audio content, for example, the speakers on a television, the speakers on a stereo, the speaker on a telephone, etc. In another example of this embodiment, if the user chooses the category “Devices”, the user is presented with a list of sub-categories of devices on the network that can be sources of content. Examples of such sub-categories are “microphones”, “pointing devices”, etc. If the user chooses “microphones”, then a list of all the microphones on the network are displayed on the left side of the screen, and a list of all the resources on the network that can accept microphone content, such as the speakers on a stereo or the speakers on a television are displayed on the right side of the screen. The user can map a source of content on the left side of the screen, such as a song, to a destination resource on the right side of the screen, such as the speaker on a television by clicking on them with a pointing device. This instructs the mapping algorithm to identify the series of routines to convert the source content to the destination content, and to store the identification of the series of routines in memory. This is referred to as a cached mapping.

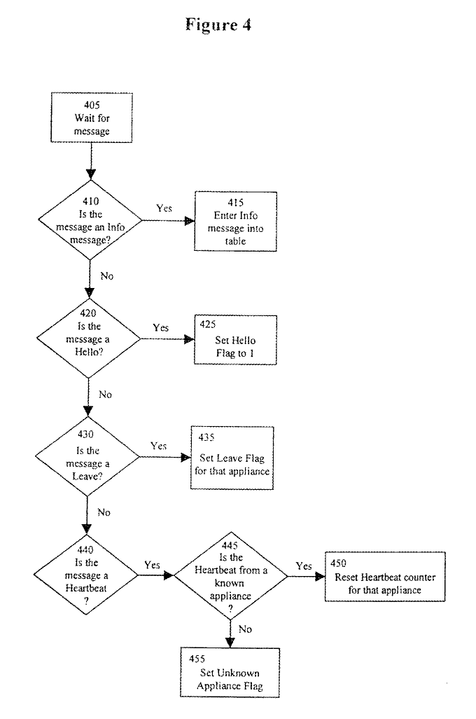

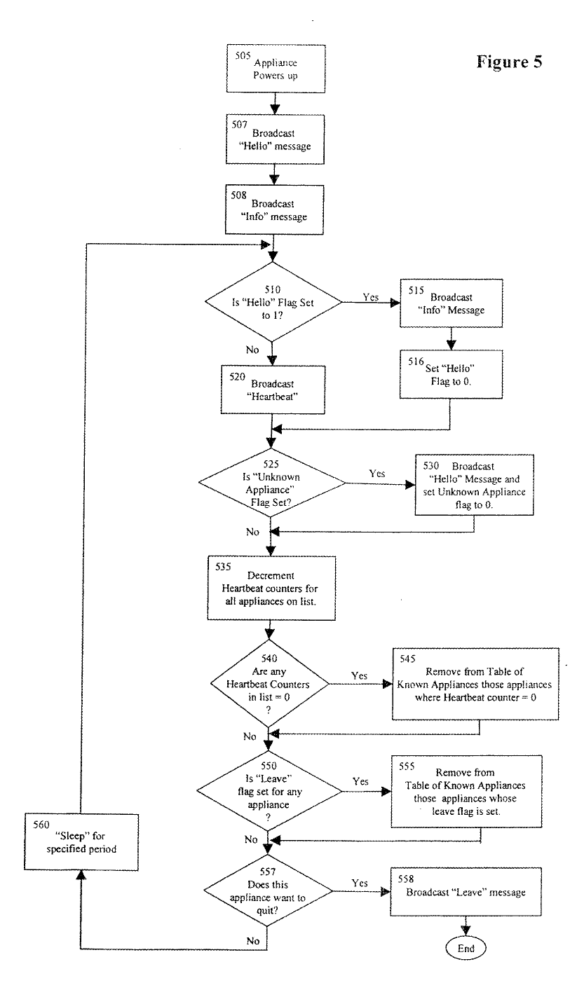

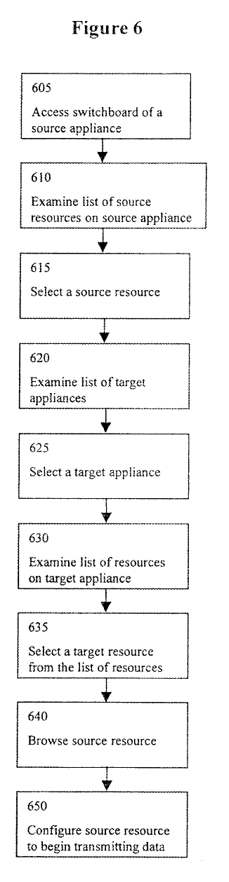

The user's ability to control the routing of content from a source resource on a source appliance to a target resource on a target appliance will now be described with reference to FIG. 6. The user located at an appliance activates the switchboard, displaying the list of resources on the appliance the user is physically using and the list of other appliances on the network discovered through the discovery process as described above with reference to FIGS. 4 and 5 are hard-coded by an administrator. The user then selects a source appliance, which displays the switchboard of the source appliance identified by the Browse URL stored in the table of known appliances (Step 605).

The list of resources on the source appliance is displayed at step 610. The user then selects a source resource (Step 615). An example of a source resource is a CD-ROM player. Next, the user examines the list of target appliances listed on the switchboard (Step 620), and selects a target appliance (Step 625). The user could stop here and jump to Step 650 to configure the source resource to begin transmitting the data (described below) to the appliance, thereby letting mapping algorithm on the target appliance decide to what resource on the target appliance the data should be directed. The target appliance directs data to default resources depending on the content-type the data represents based on the mapping algorithm. For example, media of source content-type PCM might be mapped by the mapping algorithm to a speaker.

However, the user might want the PCM data (generated by a microphone on the source device) to be directed to the screen on the target appliance. To do so, the user would continue on to Step 630 and examine the list of resources on the target appliance capable of receiving input. The user then selects at target resource from the list (Step 635). This causes the switchboard to cache the path to the targeted resource as described in U.S. patent application Ser. No. 09/304,973 entitled “Method And System For Generating A Mapping Between Types Of Data”.

At step 640, the user browses the source resource by accessing the web page identified in the Table Of Resources On An Appliance by the entry under Configure URL for this resource stored in the table of known appliances. The user then configures the source resource to begin transmitting the content (Step 650). For example, one embodiment of the web page for configuring a CD-ROM is shown in FIG. 1d. When the web page is accessed, the controls for a CD-ROM such as play, stop, fast forward and rewind are displayed in the page for the user to control.

### Discovery Process

The information about each appliance (referred to below as “Info”) stored in the Table Of Known Appliances (FIG. 2), Table Of Resources On An Appliance (FIG. 3a) and Table Of Special Cases (FIG. 3b) can be hard-coded into the tables and stored on each appliance by an administrator, or they can be discovered via a discovery process and stored on each appliance. One example of a discovery process is described below.

FIGS. 4 and 5 are two independent threads running concurrently on an appliance (or running on a network adapter 140 attached to the appliance). FIG. 4 is a flowchart representing the thread that listens for messages, and when a message is received, sets the appropriate flags or counters as described below. FIG. 5 is a flowchart representing the thread that examines the flags and counters and decides how to act on them.

The first thread in the discovery process will now be described with reference to FIG. 4. At step 405, the thread waits for a message. When a message is received from another appliance, it is checked to see what kind of message it is. At step 410, the message is checked to see if it is an Info message. An Info message, described in detail below, contains information about the appliance, including the resources attached to it and instructions detailing how to send data to the appliance and its resources. If it is an Info message, then at Step 415 the contents of the Info message are entered into the Table of Known Appliances and the Table of Resources for that appliance, and Table of Special Cases (FIGS. 2, 3a and 3b). This table is stored in the receiving appliance's memory 102 or 144. After steps 415, 425 435, 450 or 455 have been completed, thread then loops back to step 405 to wait for the next message.

If the message is not an Info message, then at step 420 the message is examined to see if it is a Hello message. Hello is a signal that an appliance broadcasts across the network to which it is attached upon power-up that signals to the other appliances on the network to broadcasts their Info message. Hello messages from all appliances are identical. This enables the newly powered-up appliance to populate its Table of Known Appliances and Table of Resources for each appliance with information about each appliance attached to the network. If the message is a Hello message, then at step 425 the Hello Flag is set to 1. The Hello flag is stored in memory 102 in the appliance or in memory 144 in network interface 140 attached to the appliance. After setting the Hello flag, the thread loops back to step 405 to wait for the next message.

If the message is not a Hello message, then at step 430 the message is examined to see if it is a Leave message. If the message is a Leave message, then at step 435 the Leave Flag is set to 1 for the appliance that sent the message. This flag can be stored in the Table of Known Appliances as shown in FIG. 2. After setting the Leave flag, the thread loops back to step 405 to wait for the next message.

If the message is not a Leave message, then at step 440 the message is examined to see if it is a Heartbeat message. If the message is a Heartbeat message, then at step 445 it is checked to see if the Heartbeat is from a known appliance. If the Heartbeat is from a known appliance, then the Heartbeat counter for that appliance is reset to a pre-defined level, for example, 6 (Step 450). The Heartbeat counter can be stored in the Table of Known Appliances as shown in FIG. 2. If the Heartbeat is from an unknown appliance, then at step 455 the Unknown Appliance flag is set. The Unknown Appliance flag can be stored in memory 102 in the appliance or in memory 144 in network interface 140 attached to the appliance.

The discovery process on an appliance will now be described with reference to FIG. 5. At step 505, an appliance powers up. An appliance is anything connected to a local network capable of identifying itself to the network. Examples are computers, DVD players, telephones, televisions, and PDAs. The appliance then broadcasts a “Hello” message. Hello is a signal that a machine broadcasts across the local network upon power up, which signals to the other appliances on the network to broadcast their “Info” messages (Step 507). The appliance then broadcasts its “Info” message across the local network (Step 508) which received by the other appliances on the local network. In response to receiving the Hello message from the appliance, the other appliances on the local network send their Info messages across the local network which are received by the appliance as described above with reference to FIG. 4.

The appliance then checks to see if the Hello flag is set to 1 (Step 510). If so, then the appliance broadcasts its Info message across the network and sets the Hello flag to 0 (Steps 515 and 516). If not, then the appliance broadcasts its “Heartbeat” (Step 520). The Heartbeat is a message sent from each appliance indicating that the appliance is still connected to the local network. It contains a unique ID for each appliance. An example of the unique ID is the IP address.

The appliance then checks to see if the Unknown Appliance flag is set to 1 (Step 525). If so, then the appliance broadcasts a Hello message so that the unknown appliances on the network broadcast their Info messages, and the Unknown Appliance flag is reset to 0 (Step 530).

The appliance then decrements the Heartbeat Counters for all of the appliances listed in the Table Of Known Appliances (Step 535). The appliance then checks to see if any of the Heartbeat Counters in the Table of Known Appliances is equal to 0 (Step 540). If so, then those appliances whose Heartbeat Counters equal 0 are removed from the Table Of Known Appliances (Step 545).

The appliance next checks to see if the “Leave” flag is set for any appliance (Step 550). If so, then any appliances whose Leave flag is set is removed from the Table Of Known Appliances, and the Table of Resources for those appliances are deleted from memory (Step 555).

The appliance then checks to see if it itself is shutting down (Step 557). If so, then the appliance broadcasts its Leave message across the network (Step 558), and the thread ends. If not, then the appliance sleeps for a specified period (Step 560), for example 10 seconds, and then loops back up to Step 510.

Although one discovery process has been described, any well-known discovery process such as Jini, NetBios Discovery, could be substituted for the above discovery process.

It will be apparent to those skilled in the art that various modifications and variations can be made in the system and processes of the present invention without departing from the spirit or scope of the invention. Thus, it is intended that the present invention cover the modifications and variations of this invention provided they come within the scope of the appended claims and their equivalents. In this context, equivalents means each and every implementation for carrying out the functions recited in the claims, even if not explicitly described herein.

What is claimed is:

1. A system for routing data across a network, comprising:
a source appliance;
a destination appliance connected to the source appliance via a network;
data of a particular source content-type to be transmitted across the network from the source appliance to the destination appliance; and
a header appended to the data, the header comprising a destination appliance routing address string and the source content-type.

2. The system of claim 1 wherein the destination appliance further comprises a processor, the processor using a mapping algorithm operating on the data to identify the destination content-type based on the source content-type and to identify the series of routines necessary to convert the source content-type to the destination content type.

3. The system of claim 2 wherein the processor further uses a demultiplexing algorithm operating on the data to effect the conversion of the content from the source content-type to the destination content type.

4. The system of claim 1 wherein the header further comprises a destination content-type.

5. The system of claim 4 wherein the header further comprises an intermediate content-type.

6. The system of claim 1 wherein the header further comprises an intermediate content-type.

7. The system of claim 1 wherein the header further comprises an intermediate appliance routing address string.

8. The system of claim 7 further comprising an intermediate appliance having a resource for converting the data from the source content-type to the destination content-type.

9. The system of claim 1 further comprising:
a memory device connected to the source appliance; and
a table of information stored in the memory device comprising a destination appliance routing address string.

10. The system of claim 9 wherein the table further comprises a destination content-type.

11. The system of claim 10 wherein the header further comprises an intermediate appliance routing address string.

12. A system for routing data across a network, comprising;
a source appliance;
a source resource connected to the source appliance;
a destination appliance connected to the source appliance via a network; and
a table of information stored in a memory device connected to the source appliance comprising the destination appliance routing address string and a destination resource content-type.

13. The system of claim 12 further comprising a destination resource connected to the destination appliance.

14. The system of claim 13 wherein the destination resource is encapsulated as a media object.

15. The system of claim 12 further comprising:
a header appended to the data, wherein the header encapsulates the data, and wherein the header comprises a destination appliance routing address string and a source content-type.

16. The system of claim 15 wherein the header further comprises a destination content-type.

17. The system of claim 15 wherein the header further comprises an intermediate appliance routing address string.

18. The system of claim 17 wherein the header does not contain information identifying the source appliance.

19. A header comprising:
a destination appliance routing address string; and
a source content-type address string appended to the destination appliance routing address string.

20. The header of claim 19 further comprising a destination content-type address string appended to the source content-type address string.

21. The header of claim 19 further comprising an intermediate appliance routing address string appended to the destination appliance routing address string.

22. A method for routing content, comprising:
building a header comprising at least a source content-type address string and a destination appliance routing address string;
encapsulating the content in the header; and
transmitting the encapsulated content across a network to a destination appliance.

23. The method of claim 22 further comprising:
identifying the source content-type by parsing the header at the destination appliance;
determining via a mapping algorithm what the target content-type should be based on the source content-type; and
converting the source content-type to the target content-type.

24. The method of claim 22 wherein the header further comprises a destination content-type address string.

25. The method of claim 24 wherein the header further comprises an intermediate appliance routing address string.
